(19) United States
(12) Patent Application Publication
(10) Pub. No.: US 2004/0222654 A1
(43) Pub. Date: Nov. 11, 2004

(54) Ash and smoke expeller

(76) Inventors: Michael D. Spiller, St. Louis, MS (US); Gina Spiller, St. Louis, MS (US)

Correspondence Address: Law Offices of John D. Gugliotta, PE, Esq., 202 Delaware Building, 136 South Main Street, Akron, OH, 44308, US

(21) Appl. No.: 10/839,839

(22) Filed: May 6, 2004

Related U.S. Application Data
(60) Provisional application No. 60/468,046, filed on May 6, 2003.

(51) Int. Cl. B60N 3/12

(52) U.S. Cl. 296/37.11

(57) ABSTRACT

An ash and smoke expeller is disclosed having an ash tray with special features to aid in the removal of smoke and ash from the interior of motor vehicles. Attached to the gear selector on a truck or similar attachment point on a dash structure of a motor vehicle, a flexible plastic hose extends from the bottom rear of the ashtray to the exterior of the vehicle. When the vehicle is moving, a vacuum is created inside of the hose when compared to atmospheric pressure inside of the motor vehicle. This vacuum draws smoke and ash particles through the hose and out of the vehicle. It is envisioned that the hose would be routed through a door opening, window opening or other space where access to the exterior environment is easy.

### RELATED APPLICATIONS

The present invention claims the benefit in priority of U.S. Provisional Patent No. 60/468,046, filed on May 6, 2003, and incorporated by reference as if fully rewritten herein.

### BACKGROUND OF THE INVENTION

1. Field of the Invention

The present invention relates generally to automobile air filtering methods and the like and, more particularly, to an automobile cigarette ash tray that utilizes a venturi-powered vacuum generate by the movement of the vehicle itself.

2. Description of the Related Art

Tobacco smokers know all too well of the difficulties associated with their habit, especially while traveling in a motor vehicle. Much of the difficulty comes from dealing with the small volume of space present inside of a motor vehicle which tends to magnify any problems. Smoke and ash tend to build up in the air quickly. This is not only a health hazard for the smoker but for any passengers as well. Additionally, smoke residue quickly accumulates on interior surfaces and glass areas causing a dirty look. Such an appearance has an obvious impact on the resale value of the vehicle should it be sold. Many drivers tend to combat this accumulation by opening or “cracking” a window to allow the quickly moving outside air to “suck” out the smoke. However, this method only works if the burning tobacco product is close the window, which is not always the case. Also, it subjects the driver and passengers to any inclement weather that may be outside such as rain, snow, cold temperatures and the like. Even if the weather is fine, the increased noise from an open window can be an annoyance.

A search of the prior art did not disclose any patents that read directly on the claims of the instant invention; however, the following references were considered related:

U.S. Pat. No. 5,968,214 issued in the name of Nagata et al., describes an air cleaning apparatus for vehicles which are disposed sequentially from the upstream side of the airflow in an air-cleaning duct.

U.S. Pat. No. 4,936,321 issued in the name of Bludis, describes an arrangement for receiving smoking residue.

U.S. Pat. No. 4,309,382 issued in the name of Miller, describes a solvent-evaporation type of deodorant added to the windshield washer fluid reservoir of a motor vehicle.

U.S. Pat. No. 6,249,645 issued in the name of Smith, describes a scent device adapted for use in a vehicle.

U.S. Pat. No. 5,192,346 issued in the name of Kowalczyk, describes an air purifier pleated flat filter installed in the vehicle to stop pollution for passengers inside.

U.S. Pat. No. 5,004,487 issued in the name of Kowalczyk, describes a filter assembly to protect passengers from pollution from inside or outside of the vehicle.

And, U.S. Pat. No. 4,282,017 issued in the name of Chen, describes an automobile dirty smoke eliminator.

Accordingly, there is a need for a means by which tobacco smokers can pursue their habit inside of a motor vehicle without the accumulation of smoke or ash without the disadvantages of an open window as described above.

### SUMMARY OF THE INVENTION

It is therefore an object of the present invention to provide an improved automobile cigarette ash tray.

It is a feature of the present invention to provide an improved automobile cigarette ash tray that utilizes a venturi-powered vacuum generate by the movement of the vehicle itself.

Briefly described according to one embodiment of the present invention, an ash and smoke expeller is disclosed having an ash tray with special features to aid in the removal of smoke and ash from the interior of motor vehicles. Attached to the gear selector on a truck or similar attachment point on a dash structure of a motor vehicle, a flexible plastic hose extends from the bottom rear of the ashtray to the exterior of the vehicle. When the vehicle is moving, a vacuum is created inside of the hose when compared to atmospheric pressure inside of the motor vehicle. This vacuum draws smoke and ash particles through the hose and out of the vehicle. It is envisioned that the hose would be routed through a door opening, window opening or other space where access to the exterior environment is easy.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a partial perspective view of the preferred embodiment of an ash and smoke expeller according the present invention; and

FIG. 2 is a pneumatic schematic drawing of the smike discharge mechansim for use therewith.

### DESCRIPTION OF THE PREFERRED EMBODIMENTS

The best mode for carrying out the invention is presented in terms of its preferred embodiment, herein depicted within the Figures.

1. Detailed Description of the Figures

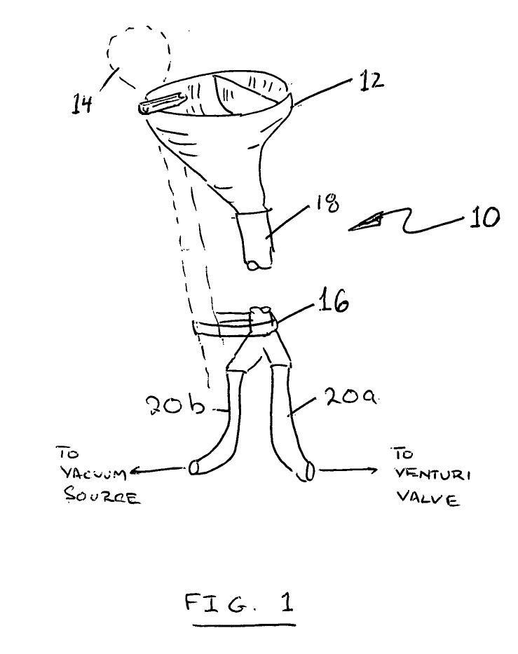

Referring now to FIG. 1, an ash and smoke expeller is disclosed, generally noted as 10, having an ash tray 12 with special features to aid in the removal of smoke and ash from the interior of motor vehicles. Although it is envisioned that the benefits of the present invention can be adapted to any vehicle ashtray, for purposes of enablement it is shown that the ash tray 12 can be attached to the gear selector 14 on a truck (or similar attachment point on a dash structure of a motor vehicle) by use of a clamp 16. A flexible plastic hose 18 extends from the bottom rear of the ashtray 12 to the exterior of the vehicle as described below.

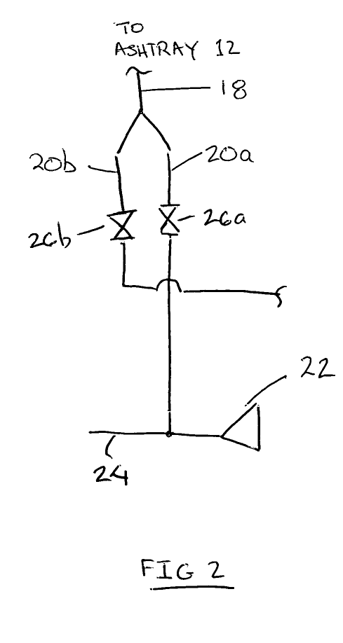

As shown in FIG. 2, the flexible plastic hose 18 is in fluid communication with a first vacuum line 20a and a second vacuum line 20b. The first vacuum line 20a is in fluid communication to a remotely placed venturi valve 22. When the vehicle is moving, a vacuum is created inside of the hose when compared to atmospheric pressure inside of the motor vehicle. This vacuum draws smoke and ash particles through the hose and out of the vehicle. It is envisioned that a discharge hose 24 would be routed through a door opening, window opening or other space where access to the exterior environment is easy. The second vacuum line 20b is in fluid communication with an existing vacuum source (not shown) provided with the vehicle, such as any of the engine vacuum lines that are generally available on existing vehicles. This vacuum draws smoke and ash particles through the hose and out of the vehicle.

It is envisioned that a first valve 26a would be located in the first vacuum line 20a in order to isolate the venturi 22 and a second valve 26b would be located in the second vacuum line 20b in order to isolate the existing vacuum source. In this manner, the venturi vacuum source can be used while the vehicle is in motion, while the existing vehicle vacuum can be used while the vehicle is running, but not in motion.

2. Operation of the Preferred Embodiment

The use of the ash and smoke expeller allows tobacco product users to enjoy their habit while driving, yet keep the interior of their vehicle clear of smoke and ash for their comfort and that of their passengers in a manner which is quick, easy and effective. Positioning of the air intake is the most important aspect of the use and functioning of the device. The intake has to have unobstructed airflow. It is anticipated that either universal mounting hardware, or that customized to a particular vehicle, will allow the components to be affixed to an existing car or truck.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be limited only by the following claims.

What is claimed is:

1. An automobile cigarette ash tray that utilizes a venturi-powered vacuum generate by the movement of the vehicle itself.

2. An ashtray smoke expeller comprising:
an ash tray mountable within the interior of a motor vehicle;
a flexible conduit extending from said ashtray to the exterior of a motor vehicle and in fluid communication with said ash tray;
a venturi valve; and
a first vacuum line in fluid communication between said flexible conduit and said venturi valve.

3. The ashtray smoke expeller of claim 2, further comprising:
a second vacuum line in fluid communicating between said flexible conduit and a vacuum means of the type existing on a motor vehicle.

4. The ashtray smoke expeller of claim 2, further comprising It discharge hose in fluid communication between said venturi valve and the exterior environment of the vehicle.

5. The ashtray smoke expeller of claim 3, further comprising means for alternately closing either said venturi valve or said vacuum means in an alternating fashion.
